(19) United States
(12) Patent Application Publication
(10) Pub. No.: US 2009/0273269 A1
(43) Pub. Date: Nov. 5, 2009

(54) SCANDATE DISPENSER CATHODE

(75) Inventors: Georg Friedrich Gartner, Aachen (DE); Ernst Klein, Roetgen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,100

(22) PCT Filed: Dec. 13, 2005
(86) PCT No.: PCT/IB2005/054197

§ 371 Date: Jun. 19, 2007

(30) Foreign Application Priority Data
Dec. 21, 2004 (EP) 04106783.6

(51) Int. Cl. H01J 1/28

(52) U.S. Cl. 313/346 DC

(57) ABSTRACT

A scandate dispenser cathode having a cathode body (4) arranged on a cathode support (3), a cathode coating (5, 6) comprising a layer system (6) consisting of one or more alternating layers of rhenium or a rhenium alloy (61) and of scandium oxide or a scandium alloy (62), and an activation acceleration layer system (5) arranged between the cathode body (4) and the layer system (6), said activation acceleration layer system comprising at least one release layer (52) comprising alkaline earth metal oxide, preferably barium oxide, and an activator layer system (51) comprising a barrier material with greater oxidation resistance than the material of the cathode body and an activator material for reducing the alkaline earth metal oxide, preferably barium oxide.

The invention relates to a scandate dispenser cathode for electron emission and to a vacuum electron tube comprising a scandate dispenser cathode.

Scandate dispenser cathodes are known as cathodes with a very high electron emission. Document DE19828729 describes a scandate dispenser cathode which consists of a cathode body, a base layer and a cathode coating with an emitting surface. The cathode coating which is applied to the cathode body consists of one or more layers which contain rhenium and/or a rhenium alloy and of one or more layers which contain scandium oxide, said layers being arranged in an alternating manner. The cathode body consists of a matrix of at least one high-melting metal and/or one high-melting alloy and of a barium compound which is provided to supply barium to the emitting surface by means of a chemical reaction with the matrix material. The matrix preferably consists of a porous tungsten matrix produced from tungsten powder using a powder-metallurgical method. This porous matrix is impregnated with a mixture of BaO, CaO and Al₂O₃. To this end, a mixture of BaCO₃, CaCO₃ and Al₂O₃ is melted and the porous matrix is filled with the mixture by melt infiltration. The surface of the body is then cleaned of the oxide mixture adhering to the outside by means of ultrasound and water, and is then provided with a barium-containing base layer. Although this scandate dispenser cathode has a long service life, a high electron current density and a uniform emission over the cathode surface, the significant problem with scandate dispenser cathodes nevertheless still exists, namely the fact that, after a typical 2-hour activation phase, an additional operating time of more than 100 h at a typical operating temperature of 1033° C. is required until the maximum emission current density of more than 300 A/cm² is reached. This problem could not be alleviated by the additional barium-containing base layer between the cathode body and the cathode coating which is described in said document. A considerable lengthening of the activation phase in order to more rapidly reach the maximum emission current density is moreover not practical on account of the high evaporation rate of the electron-emitting material at activation temperatures, since this is therefore associated with a reduction in the service life of the cathode and an increase in the risk of insulation faults on account of soiling of the means for guiding the electron beam.

It is therefore an object of the present invention to provide an improved scandate dispenser cathode which, under the same activation conditions, exhibits a maximum emission current density just after the activation phase has ended.

This object is achieved by a scandate dispenser cathode having a cathode support, a cathode body, a cathode coating comprising a layer system consisting of one or more alternating layers of rhenium or a rhenium alloy and of scandium oxide or a scandium alloy, and an activation acceleration layer system arranged between the cathode body and the cathode coating, said activation acceleration layer system comprising at least one release layer comprising alkaline earth metal oxide, preferably barium oxide, and an activator layer system comprising a barrier material with greater oxidation resistance than the material of the cathode body and an activator material for reducing an alkaline earth metal oxide, preferably barium oxide. By virtue of the arrangement of the activation acceleration layer system according to the invention between the cathode body and the scandium-containing layer system, an alkaline earth metal source, preferably a barium source, which is protected against oxidation is arranged in the vicinity of the scandium oxide or scandium alloy layer for the accelerated formation of an emitting alkaline earth metal/scandate complex, preferably a Ba/scandate complex. The elemental alkaline earth metal which is required, preferably barium, is released by the reducing action of the activator materials which diffuse thermally from the activator layer system into the release layer. The barrier material protects the activator material and the released alkaline earth metal, preferably barium, against oxidation by oxygen from the cathode body.

It is advantageous if the barrier material comprises at least one element from the group Re, Ir, Ru, Pt, Ni. These elements are much more inert than the material of the cathode body, typically tungsten, that is to say they oxidize much less readily than the material of the cathode body.

It is particularly advantageous if the activator material consists of at least one element from the group C, Zr, Mg, Al, Si. These elements have a high diffusion rate at cathode operating temperatures and together with the alkaline earth metal oxide, preferably barium oxide, form an activator material oxide and elemental alkaline earth metal, preferably barium.

In one advantageous embodiment, the activator layer system comprises a layer of at least one barrier material and dopings of at least one activator material.

In another advantageous embodiment, the activator layer system comprises a first layer and a second layer of at least one barrier material and an activator layer of at least one activator material which is arranged between the first and second layer, which activator layer is compact or may consist of ultrafine particles. The term “ultrafine particles” means particles having a particle diameter of between 1 nm and a few hundred nm.

In another advantageous embodiment, the activator layer system comprises one or more layers of ultrafine particles of at least one activator material and at least one barrier material, wherein the barrier material encapsulates the activator material.

It is moreover advantageous if the activation acceleration layer system has a thickness of between 30 nm and 10 μm, in order that a sufficient barrier effect is achieved for preventing oxidation of the activator materials or of the alkaline earth metal, preferably barium, which is produced, the diffusion distance of the activator materials into the release layer is not too long and thus the rate of reduction of the alkaline earth metal oxide, preferably barium oxide, is not too low, and a sufficient amount of alkaline earth metal oxide, preferably barium oxide, is available for the reduction.

It is particularly advantageous if the cathode support comprises a protective device which covers part of the layer system above the layer system, as seen in the emission direction. The material which has been evaporated from the surface of the layer system that does not contribute to the electron beam thus precipitates on the inner side of the protective device (the side which faces the surface of the layer system), and any soiling of the cathode surroundings, for example of devices for guiding the electron beam, is at least considerably reduced.

The invention also relates to a vacuum electron tube comprising at least one scandate dispenser cathode as claimed in any of the preceding claims.

The invention will be further described with reference to examples of embodiments shown in the drawings to which, however, the invention is not restricted.

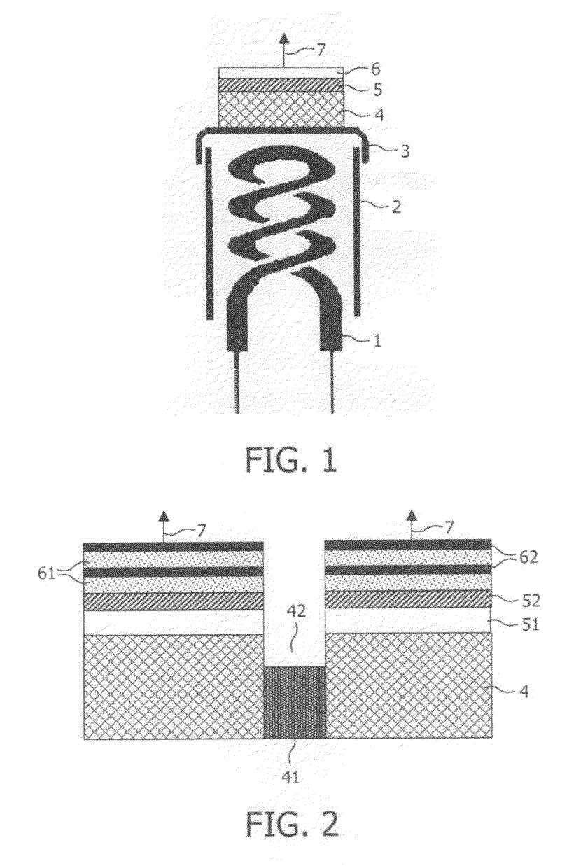

FIG. 1 shows a scandate dispenser cathode according to the invention.

FIG. 2 shows a cathode body with a cathode coating according to the invention.

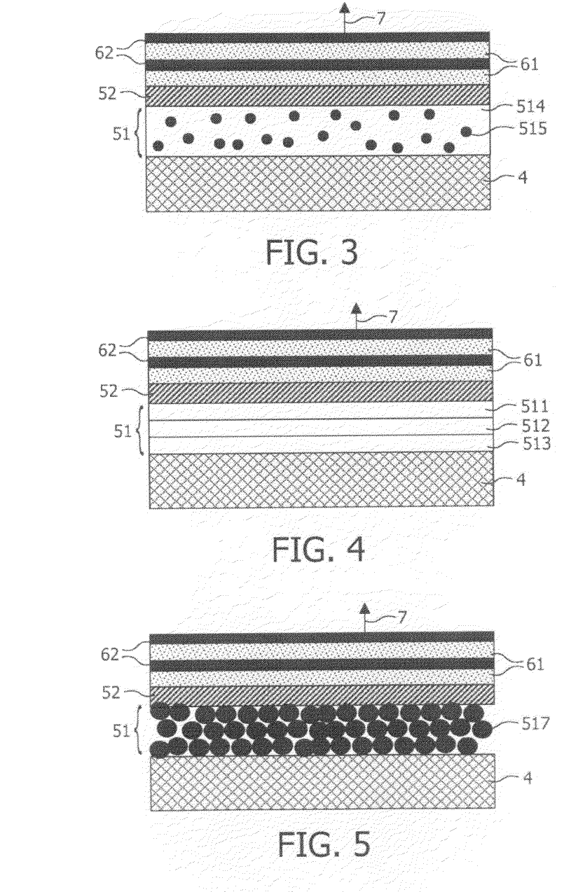

FIG. 3-FIG. 5 show various embodiments of the activation acceleration layer system according to the invention.

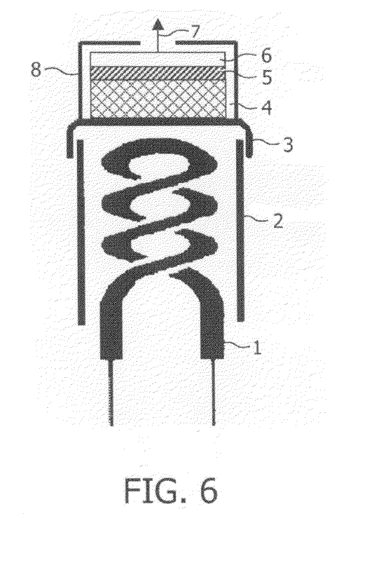

FIG. 6 shows a scandate dispenser cathode according to the invention with a protective device.

Scandate dispenser cathodes are used in a large number of vacuum electron tubes, particularly as cathodes in systems for electron beam lithography, but also in CRTs, microwave tubes, high-frequency tubes, X-ray tubes or thermionic converters. At start-up, the scandate dispenser cathodes run through an activation phase at activation temperatures above the operating temperature. Typical activation times are 2 h. At typical operating temperatures of 1033° C., conventional scandate dispenser cathodes without an activation acceleration layer system 5 according to the invention exhibit a relatively slow rise in electron emission over typically 100 operating hours until a maximum saturation emission of 300 A/cm² to 400 A/cm² is achieved. Although the duration of the rise in the saturation emission up to the maximum value can be shortened by an extended activation phase at temperatures which are considerably above the operating temperature, this is not advantageous on account of the increased evaporation of emitter material, in particular barium, and the associated shortening of the service life. In addition, increased evaporation of emitter material causes soiling of the cathode surroundings, particularly of means for focusing and deflecting the electron beam, and this leads to impairment of the operating properties of the vacuum electron tube.

FIG. 1 shows a scandate dispenser cathode according to the invention, comprising a heating coil 1 for generating the operating temperature, typically 1033° C., a cathode shaft 2 for preventing heat losses and for holding the cathode support 3 and a cathode body 4 arranged on the cathode support 3, a cathode coating 5 and 6 comprising a layer system 6 consisting of one or more alternating layers (cf. FIG. 2) of rhenium or a rhenium alloy 61 and of scandium oxide or a scandium alloy 62, and an activation acceleration layer system 5 arranged between the cathode body 4 and the layer system 6, said activation acceleration layer system comprising at least one release layer 52 comprising alkaline earth metal oxide, preferably barium oxide, and an activator layer system 51 comprising a barrier material with greater oxidation resistance than the material of the cathode body and an activator material for reducing the alkaline earth metal oxide, preferably barium oxide.

In scandate dispenser cathodes according to the prior art, the slow rise in the saturation emission once the activation phase is complete is due to the fact that the high-emitting Ba/scandate complex is formed from the deposited scandium-containing layers 62 and the atomic barium which is produced only at activation and operating temperatures (cf. FIG. 2) by a chemical reaction of a barium oxide-containing impregnate 41 with the material of the cathode body 4 in the region of the pores 42 of the cathode body 4. The barium passes into the scandium-containing layers 62 by means of slow surface and solids diffusion. The scandate dispenser cathode according to the invention as shown in FIG. 1 comprises an activation acceleration layer system 5 with an alkaline earth metal source in the form of a release layer 52 comprising an alkaline earth metal oxide below the layer structure 6, cf. FIG. 2, said alkaline earth metal source being protected against oxidation by an activator layer system 51. In one preferred embodiment, this layer 52 consists of a barium-containing mixture of alkaline earth metal oxides, for example a mixture of barium oxide, strontium oxide and calcium oxide. In an even more advantageous embodiment, the release layer 52 consists of barium oxide. The activator layer system 51 comprises a material, preferably consisting of at least one element from the group Re, Ir, Ru, Pt, Ni, with a higher oxidation resistance than the material of the cathode body and thus forms a barrier layer for preventing oxidation of the alkaline earth metal which has been released in the release layer 52. The release of alkaline earth metal, preferably barium, is made possible by an activator material. The activator material contained in the activator layer system 51, which is preferably an element from the group C, Zr, Mg, Al, Si, has a high diffusion constant and therefore rapidly. diffuses into the release layer 52 at the activation temperatures of the cathode and thus brings about a reduction of alkaline earth metal oxide, preferably barium oxide, and thus a release of atomic alkaline earth metal, preferably barium, to form the high-emitting alkaline earth metal/scandate complex, preferably a Ba/scandate complex. By virtue of the arrangement of the release layer 52 below the layer system 6, the released alkaline earth metal atoms, preferably barium atoms, can rapidly diffuse into the adjacent scandium-containing layers 62 and form the high-emitting alkaline earth metal/scandate complex, preferably a Ba/scandate complex, much faster than is the case when the alkaline earth metal is formed exclusively on the walls of the pores 41 within the cathode body 4 and thus has to travel over long diffusion distances to reach the layers 62.

The cathode coatings 5 and 6 can be produced by means of conventional coating methods. These methods include for example powder-metallurgical methods, CVD, PCVD, sputtering, vapor deposition and laser ablation deposition (LAD) for producing and coating with ultrafine particles. The activation acceleration layer system 5 according to the invention may be formed in various ways.

In one advantageous embodiment (cf. FIG. 3), a layer 514 of barrier material comprising activator material 515 as doping is applied to the cathode body 4 in order to at least greatly reduce the oxidation of the layers arranged thereabove as seen in the emission direction 7. The rate of diffusion of the activator material 515 into the release layer 52 is determined by the element-specific diffusion constant of the activator material 515, the concentration of the activator material 515 in the barrier layer 514, the grain structure thereof and the operating temperature. The rate at which the alkaline earth metal oxide, preferably barium oxide, then reduces and thus at which atomic alkaline earth metal, preferably barium, is released is determined by the composition of the release layer 52. The rate of production of the alkaline earth metal is highest when the layer 52 consists entirely of barium oxide. However, release layers having a different composition are also possible, for example a mixture of Ba oxide, Sr oxide and/or Ca oxide for adjusting the vapor pressure of the release layer.

In another advantageous embodiment (cf. FIG. 4), a layer 513 of barrier material is applied to the cathode body 4 in order to at least greatly reduce the oxidation of the layers arranged thereabove as seen in the emission direction 7. An activator layer 512 of activator material is applied to the layer 513, said activator layer being arranged below a further layer 511 of barrier material in order to control the rate of diffusion of the activators into the release layer 52. The release layer 52 is arranged above this further layer 511. The rate of diffusion of the activator material into the release layer 52 is determined by the element-specific diffusion constant of the activator material, the operating temperature and the layer thickness of the barrier layer 511 and the grain structure thereof. The activator layer 512 may in this case be formed as a compact layer or as a porous layer consisting of one or more layers of ultrafine particles.

In yet another advantageous embodiment (cf. FIG. 5), the activator layer system 51 consists of one or more layers of ultrafine particles 517 of barrier material and activator material, wherein the structure of the particles is such that more effective protection of the activator material by the barrier material is achieved. By way of example, the barrier material encapsulates the activator material. The thickness of the activator layer system is such that the atomic alkaline earth metal produced in the release layer 52, preferably barium, can be oxidized only to a negligible degree or not at all by oxygen from the cathode body 4. The rate of diffusion of the activator material into the release layer 52 is determined by the element-specific diffusion constant of the activator material, by the properties of the ultrafine particles, such as size, density and quantity ratio between activator material and barrier material, and by the evaporation properties at the surface of the particles and by the operating temperature.

The aforementioned layers according to the invention are produced either via thin-layer deposition methods such as, for example, vapor deposition, sputtering or CVD, or by methods for producing ultrafine particles. The layers can be produced very easily by laser ablation deposition (LAD) by alternating the deposition mode. Compact layers such as, for example, barrier layers consisting of Pt, Zr and/or Re can be produced by low-pressure LAD at coating pressures of between 0.1 and 0.01 mbar. The same applies in respect of layers with activator material already incorporated therein. A layer of ultrafine particles is obtained for example at coating pressures of 2-5 mbar. In order to prevent oxidation of the activator material, ultrafine particles of activator material can be encapsulated by barrier material by coating the particles of activator material, which are produced at a relatively high pressure, with barrier material in a second, differentially pumped area at low pressure and in a fly-through method. Encapsulation of the ultrafine particles would also be possible by means of a subsequent wet-chemical process.

Finally, the activator layer system according to the invention can also be produced by spot-welding a sheet of barrier material which is doped with activator material onto the cathode body. To this end, however, the sheet must be perforated beforehand for the necessary diffusion of barium from the cathode body to the layer system 6.

It is particularly advantageous if the activation acceleration layer system 5 has a thickness of between 30 nm and 10 μm, depending on the embodiment.

By way of example, a scandate dispenser cathode according to the invention which has a barium-containing release layer 52 is characterized by complete activation up to an emission current density of 400 A/cm² within the activation period of 2 h at activation temperatures between 1130° C. and 1160° C., since a much larger amount of Ba/scandate complex is formed during the activation phase on account of the activation acceleration layer system according to the invention. In addition, the scandate dispenser cathode according to the invention has a greater uniformity of emission, higher resistance to ion bombardment within the vacuum electron tube following ionization of the residual gas by the electron beam, and a longer service life.

The activation acceleration layer system according to the invention can also advantageously be applied to base layers for oxide cathodes, with double and/or triple carbonate doped with Sc₂O₃ or another Sc-containing compound then being applied thereto by spraying. A high-emitting Ba/scandate complex is also formed much more rapidly in the activation phase in this case.

Finally, a cathode variant can be produced with a compact (Ba scandate and rhenium) layer on a base layer which is coated with a barium oxide-containing intermediate layer and is doped with activator material, wherein there is no need for the impregnated cathode body. As a result, very flat emitters with just small surface roughnesses can advantageously be produced.

The embodiments explained with reference to the figures and the description are merely examples of a scandate dispenser cathode for electron emission or of a vacuum electron tube, and are not intended to be understood as restricting the patent claims to these examples. Alternative embodiments are also possible for the person skilled in the art, and these are also covered by the scope of protection of the patent claims. The numbering of the dependent claims is not intended to imply that other combinations of the claims do not also constitute advantageous embodiments of the invention.

1. A scandate dispenser cathode having a cathode body (4) arranged on a cathode support (3), a cathode coating (5, 6) comprising a layer system (6) consisting of one or more alternating layers of rhenium or a rhenium alloy (61) and of scandium oxide or a scandium alloy (62), and an activation acceleration layer system (5) arranged between the cathode body (4) and the layer system (6), said activation acceleration layer system comprising at least one release layer (52) comprising alkaline earth metal oxide, preferably barium oxide, and an activator layer system (51) comprising a barrier material with greater oxidation resistance than the material of the cathode body and an activator material for reducing the alkaline earth metal oxide, preferably barium oxide.

2. A scandate dispenser cathode as claimed in claim 1, characterized in that the barrier material comprises at least one element from the group Re, Ir, Ru, Pt, Ni.

3. A scandate dispenser cathode as claimed in claim 1, characterized in that the activator material consists of at least one element from the group C, Zr, Mg, Al, Si.

4. A scandate dispenser cathode as claimed in claim 1, characterized in that the activator layer system (51) comprises a layer (514) of at least one barrier material and dopings (515) of at least one activator material.

5. A scandate dispenser cathode as claimed in claim 1, characterized in that the activator layer system (51) comprises a first layer (511) and a second layer (513) of at least one barrier material and an activator layer (512) of at least one activator material which is arranged between the first and second layer.

6. A scandate dispenser cathode as claimed in claim 5, characterized in that the activator layer (512) consists of ultrafine particles of at least one activator material.

7. A scandate dispenser cathode as claimed in claim 1, characterized in that the activator layer system (51) comprises one or more layers of ultrafine particles (517) of at least one activator material and at least one barrier material, wherein the barrier material encapsulates the activator material.

8. A scandate dispenser cathode as claimed in claim 1, characterized in that the activation acceleration layer system (5) has a thickness of between 30 nm and 10 μm.

9. A scandate dispenser cathode as claimed in claim 1, characterized in that the cathode support (3) comprises a protective device (8) which covers part of the layer system (6) above the layer system (6), as seen in the emission direction (7).

10. A vacuum electron tube comprising at least one scandate dispenser cathode as claimed in claim 1.
